(19) United States
(12) Patent Application Publication
(10) Pub. No.: US 2013/0268305 A1
(43) Pub. Date: Oct. 10, 2013

(54) Social club networking environment

(71) Applicant: Social Club Hub, Inc., Palm Beach Gardens, FL (US)

(72) Inventors: Gerard E. Glennon, Delray Beach, FL (US); Gary J. Sonnett, Frisco, CO (US); Calvin A. Wantland, Palm Beach Gardens, FL (US)

(21) Appl. No.: 13/858,555

(22) Filed: Apr. 8, 2013

Related U.S. Application Data
(60) Provisional application No. 61/621,699, filed on Apr. 9, 2012.

(51) Int. Cl. H04L 12/58

(52) U.S. Cl. CPC H04L 51/32
USPC 705/5; 709/204; 705/14.66; 705/14.73; 705/14.45

(57) ABSTRACT

The instant invention is a method of organizing and displaying independent social club and social club events through a social network environment in which social club links and social club events are stored, organized, displayed and linked in such a manner that an individual may investigate a social club and join if desired or a member from one club may investigate and access another social club or another social club event for participation.

### PRIORITY CLAIM

In accordance with 37 C.F.R. §1.76, a claim of priority is included in an Application Data Sheet filed concurrently herewith. Accordingly, the present invention claims priority under 35 U.S.C. §§119(e), 120, 121, and/or 365(c) to U.S. Provisional Patent Application No. 61/621,699, entitled “SOCIAL CLUB NETWORKING ENVIRONMENT”, filed on Apr. 9, 2012. The contents of which the above referenced application is incorporated herein by reference in its entirety.

### FIELD OF THE INVENTION

The present invention is directed generally to social networking and in particular a method of organizing and displaying independent social club events through a social network environment in which club events are stored, organized, displayed, and linked in such a manner that a member from one club may investigate and access a social event from another club for possible participation.

### BACKGROUND OF THE INVENTION

The world of social interaction has seen a phenomenon develop over the recent past, made possible by the creation and maturity of the Internet and its use by most everyone. From Facebook and LinkedIn, to Twitter and YouTube, social media and social networking websites have been redefining the way people connect, interact and do business. Such websites allow individuals to instantly connect based on education, profession, interests and hobbies.

The general principles of social networking sites have been disclosed variously in U.S. Pat. Nos. 7,249,123, 7,669,123, and 7,269,590, which are incorporated herein by reference. U.S. Pat. No. 7,249,123 discloses a system and a method for building social networks based on shared virtual objects, including document attributes, activities and associated persons. U.S. Pat. No. 7,669,123 discloses a method for displaying a user-generated news feed in a social network environment that allows users to share news messages with a predetermined set of viewers. U.S. Pat. No. 7,269,590 discloses a method directed to managing a social network user's personal information based on user-defined criteria, over a social network environment.

However, while social networking sites such as these provide great opportunities for individuals to connect, reconnect and interact, such sites have not promoted actual physical contact and interaction. On the contrary, such social networking could actually drive individuals to be more alone because the only interaction is between the individual, his/her computer and a virtual world.

One activity that has historically brought people together is the participation in clubs. All over the United States and abroad, there are numerous social clubs, sports clubs, civic clubs, charitable clubs, and ethnic clubs that allow individuals to gather and coalesce around common interests, hobbies and backgrounds. These clubs allow for consistent physical contact and human interaction. Such clubs are always seeking to bring in new members since their success and survival depends on having enough members to financially support the activities of the club and participate in its events.

On a regular basis, clubs may experience a loss of members, either through existing members becoming less involved, moving to a different location or just looking for new and different experiences. In order for clubs to thrive, it is essential that they continue to recruit and bring in new members. Unfortunately, most clubs struggle to attain enough public recognition to fulfill this goal.

Further, in general, most clubs center on one single activity, such as biking, boating, dancing, fishing, running, or the like. However, most of the members of a single club have more than just that one interest. For example, a person may be interested in snow skiing and is therefore a member of a local ski club in the winter. However, that individual may also be interested in fishing, biking or traveling, especially in the summer months, and such activities are not offered through the local ski club. Many individuals may be open to possibly joining other clubs or groups that appeal to their other varying interests.

Thus what is lacking in the art is a means for facilitating social club involvement, participation and integration that allows numerous people in all areas of the United States and other countries to expand their social interaction with others through participation in social events and activities, and allow social clubs in all areas to be seen by a multitude of individuals that may have interest is such social clubs' activities.

### SUMMARY OF THE INVENTION

The instant invention is a method of organizing, displaying and storing independent social club events through a social network environment that provides individual users with an organization based on interest topics and a calendar of social club events relating to such interest topics whereby a member from one club may investigate a social event from another club for possible participation. In particular, the method will link the websites of all clubs, whether they are local, national or international, so that a member of one club will be able to see and access the website and social events of another club. In addition, a message board allows for at least one individual of a social club to post information such that at least one individual of another social club can receive and respond to such post. Also, a chat room allows for at least one individual of a social club to communicate such that at least on individual of another social club receives and can respond to such communication. Further, the present invention allows for advertisers to display advertisements and merchandise discounts specifically directed to individual interests and to social interaction club membership interests. Advertiser information can be organized alphabetically, geographically or by product/service type.

It is an objective of the present invention to organize and display independent social clubs events of at least one link to a social club with at least one link to another social club within a set radius of mileage.

Another objective of the present invention is to organize and display advertisements and merchandise discounts within a set radius of mileage from at least one social club.

Still another objective of the present invention is to provide a location for an individual to review club memberships and provide application information for the individual to become a member of any listed social club.

Still another objective of the present invention is to allow an individual user to become a member of another social club.

Another objective of the present invention is to provide a mechanism for individuals that are not members of any social club but are seeking to expand their social life and meet new people wherein the individuals can explore the social club events.

Still another objective of the present invention is to provide a website that allows individuals that are not members of any existing club to view social events that they can attend as a guest thereby providing them with the ability to enhance their social life. Search terms for the website can be posted on Google, Bing or the like search engine.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a flow diagram depicting a method of club registration in the social club social networking environment;

FIG. 2 is a flow diagram depicting a method of operation by advertisers in the social club social networking environment;

FIG. 3 is a flow diagram depicting member registration; and

FIG. 4 is a flow diagram depicting individuals not registered.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

With reference to Figures, the present invention involves a method of organizing, displaying and storing independent social club events through a social network environment that provides individual users with an organization based on interest topics and a calendar of social club events relating to such interest topics whereby a member from one club may investigate a social event from another club for possible participation. In particular, the method will link the websites of all clubs, local, national and abroad, so that a member of one club will be able to see and access the website and social events of another club. In addition, a message board allows for at least one individual of a social club to post information such that at least one individual of another social club can receive and respond to such post. Also, a chat room allows for at least one individual of a social club to communicate such that at least on individual of another social club receives and can respond to such communication. Further, the present invention allows for advertisers to display advertisements and merchandise discounts specifically directed to individual interests and to social interaction club membership interests. Advertiser information can be organized alphabetically, geographically or by product/service type.

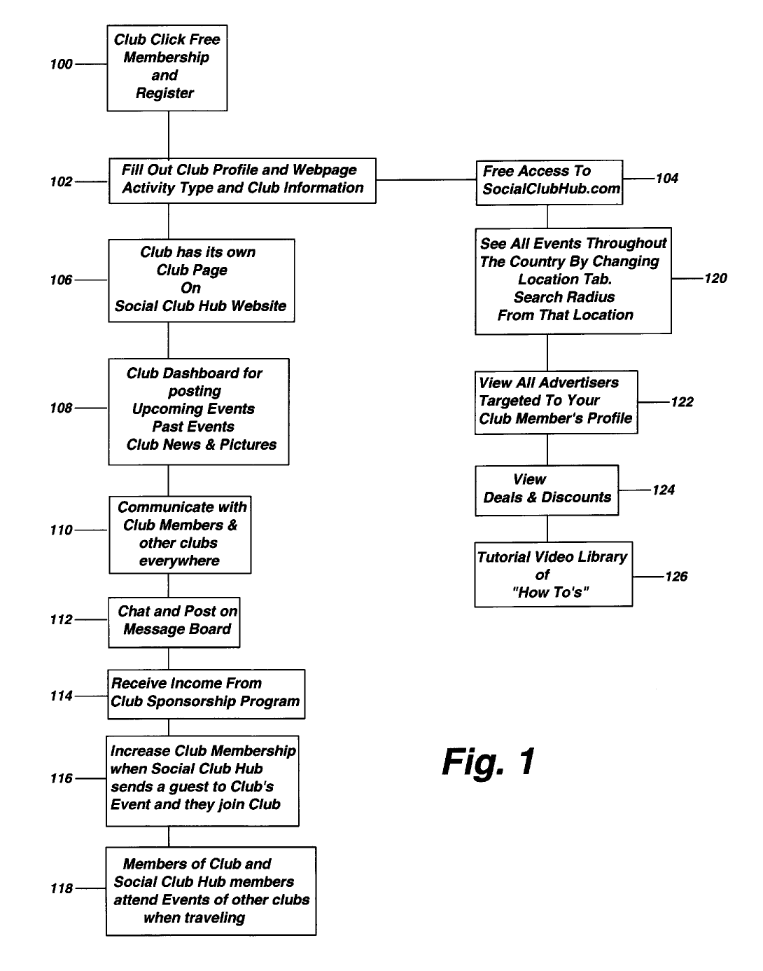

Turning to FIG. 1, a flow diagram depicting a method of club registration in the social club social networking environment is illustrated. The administrator or operator of a social club website begins by connecting to the Internet and accessing the social club social networking environment. The administrator of the social club website can then signup for a membership 100. Upon signing up for a membership, the administrator then fills out a social club profile, including the social club information, activity type, and webpage information 102. After completing the social club profile, the social club website is granted free access to the social club social networking environment 104. With this access, the social club has its own social club page 106 on the Social Club Hub website where the social club can post upcoming events, past events, social club news, and pictures for all members and website users to see 108. In addition, the social club is able to communicate with club members and other social clubs on the website 110 and may further use a chat room and a message board 112. Upon becoming a member of the Social Club Hub, a social club can receive income from a Social Club Sponsorship Program 114 and can increase the member of the social club by receiving guest individuals from another social club on the website 116. In addition, with this access, the social club can see all events of all social clubs throughout the country simply by changing the location tab and search radius to that location 120. The social club can, and its members can, view all advertisers targeted to the interests and profile of the social club 122, and can further see all the deals and discounts offered by advertisers 124. The social club can also access a tutorial video library of “how to's 126”

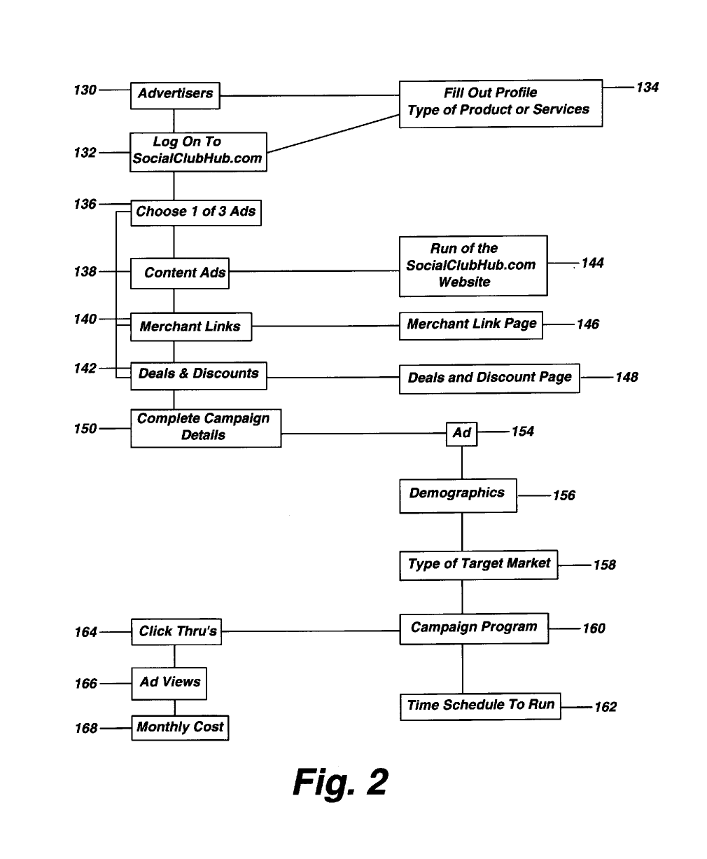

Turning to FIG. 2, a flow diagram depicting a method of operation by advertisers in the social club social networking environment is illustrated. The advertisers 130 begin by connecting to the internet and accessing the social club social networking environment 132. The advertiser log on to the network and fill out a profile 134 detailing the type of product or services that the advertiser provides. After filling out a profile the advertiser can initiate an advertising campaign and can chose any one of, or all, of three options 136: content advertisements 138, merchant links 140, and deals and discounts advertising 142. Content advertising 138 uses the profiles that social club members fill out indicating their age, gender, interests and hobbies, as well as the type of clubs they are interested in to send targeted advertisements that would appeal to specific members and club interests and club location that is based upon current website collected information 144. Merchant links 140 allow an advertiser to pay a slightly lesser fee than the content advertising and allow for an advertiser to simply place their advertisement on the social club hub website without specific content or targeting benefits by use of a merchant link page 146. Deals and discounts advertising 142 allows merchants to offer specific content or targeting deals and discounts 148 relating to the social club member interests and location.

Upon initiating an advertising campaign 150, an advertiser can then establish the type 154 of advertisement he wants, the demographic 156 he is targeting, the type of market 158 he seeks to advertise in, the type of campaign program 160 and the time and schedule 162 that the advertisement will run. The advertiser can choose between three campaign programs, each of which alter how the advertiser will pay: click thru's 164, advertisement views 166, or monthly cost 168. Click thru's 164 and advertisement views 168 require that the advertiser pay a small pay-per-click or pay-per-view fee each time a person clicks on, or views, the webpage containing the advertisement.

The present invention includes organizing and displaying independent social club websites and social club events through the social network environment which includes storing social club websites and calendar based social club events on an internet accessible database, organizing said social club websites and said database of calendar based social club events by interest topic, displaying said social club websites and said interest topics on an internet accessible computer and providing a link between said interest topics and said social club that is sponsoring the social club event. The individual user can view various events organized by interest topic from multiple social club and social club websites such that the individual user can decide to participate in the social club events. Further, the present invention includes a link which allows an individual user to become a member of another social club.

A provision of the system generates location information associated with at least one website of at least one social club in a social network environment. The software can organize at least one link to a social club, social club event, or advertiser with at least one link to another social club or another social club event within a radius of mileage or location that can be set by an individual user such that only social clubs, social club events, and advertisers within that area will appear.

A database can be organized based upon an individual user's interests, hobbies, and social interaction club membership interests. The database stores user information, interests, hobbies, and other individualized data. Upon organizing and storing said database, advertising is generated and displayed to the individual directed to the individual's interests and social interaction club membership interests. A link is provided with at least one of the advertisements to at least one of the websites of the advertisers allowing any individual to access the website of the advertiser. An advertiser is allowed to organize and display the advertiser information alphabetically, geographically or by product/service type. The advertiser is further allowed to organize and display a merchandise discounts display and link.

The social club event activities can be characterized to include, but are not limited to, events such as: arts & crafts, bike/cycling, boating, book, bowling, business group, civic group, computer, cooking, dancing, dining, fishing, game, gardening, golf, poppy motorcycle, music pet, photography, professional sports, running, scuba diving, snow ski/snowboarding, social group, tennis, travel, volunteer, wine tasting, search groups and so forth. The activities are displayed such that at least one event link allows access to at least one list of upcoming events of at least one social interaction club. Should an activity such as boating be elected, a further screen display would least those social clubs that include boating as an activity. An icon for different clubs would indicate club participation. For instance, under boating you would find South Florida clubs such as the Florida Powerboat club, the Lauderdale Small Boat Club, Miami Outboard Club, Miami Multihull Association of South Florida, U.S. PHRF of Southeast Florida and Southeast Florida Yacht Club, and so forth. From this list a member can link to one of the social club sites and review the events, and participate in such an event.

An independent social club can be provided space to organize and display a message board for the club to post such information such that at least one individual of another social club receives and can respond to such post. Further, an independent social club can organize and display a chat room for at least one individual of a social club to communicate, such that at least one individual of another social club receives and can respond to such communication.

The social club website will consist of a number of access tabs, each having a specific function. For instance, in the preferred embodiment, a list of tabs includes the following tabs:

“Partner Links” will have a drop down list of advertisers in random order that can be organized geographically (city, state or current location) and by product/service type by using a “search selection menu”. Upon opening “Partner Links” it will default to a radius of 20 miles around our website member's current location and a radius box to select a wider radius. The radius box will show that the default radius is 20 miles. All advertisers that are regional and national will also appear. There will also be a city/state/current location box where the member can change the location in the case when they are going to be traveling to another area and want to see the events in that local area. This page will show a thumbnail picture of all the advertiser's webpages, along with a tag line under the thumbnail. A “quickview” text box will also come up to the right of the thumbnail stating the name of the club, location, distance from our website member's location and the club's website address. Clicking any advertiser's website picture will take the member to that advertiser's website through a link. At the top of the page there should be a tab to click for prospective new advertisers to contact the applicant, i.e. “Advertise”, which should bring up a contact person including, address, phone number, e-mail address and a box to fill for immediately sending an e-mail. When an advertiser signs up they can designate whether they want to advertise on a national, regional and/or local basis, a website member's current location will interact with this request. A provision can be used to track hits to advertiser's website as well as sales made through the website. One example of a current location locator can include an individual's zip code.

“Activities” brings up a list of all activity types. Clicking a specific activity tab brings up a box to put in a location city, state or current location. There will also be a “range of distance” option so the members can select a radius of 5, 10, 15, etc. After pressing an “Enter” box a thumbnail picture of all the club webpages for that particular type activity in that local area will appear, along with a tag line under the thumbnail. A “quickview” text box will also come up to the right of the thumbnail stating the name of the club, location, distance from our website member's location and the club's website address. Clicking any of the club website pictures will take the member to that club's website through a link. There must be software to track “click thru's” to each website, as well as overall totals to all websites. After a website member logs in, when viewing the “Activities” page the Activity tabs on the left side of the home page will not be visible, but will reappear when the “Activities” page is closed.

“Events” defaults to a radius of 20 miles around our website member's current location and a radius box to select a wider radius. The radius box will show that the default radius is 20 miles. There will also be a city/state/current location box where the member can change the location in the case when they are going to be traveling to another area and want to see the events in that local area. There will be only one event pane organized chronologically. When the cursor is placed over a club event it will show the hand icon indicating that it can be clicked for more information. A thumbnail picture of the club's website icon is displayed so a member can also click to see the club's website. When a website member views an upcoming event and clicks on the event, included in the description of the event is an e-mail message box that will appear sending a message to a designated member of that club informing that person that a website guest will be coming, and the club representative can send an e-mail reply welcoming the guest, with a contact name of a club member to ask for when they arrive so they can be introduced around. When the cursor is placed over an advertiser's event a small “quickview” will appear where the advertiser will have the ability to post a picture and/or a few lines of text to promote his event. There can also be the hand icon indicating that it can be clicked and the full information on the event will appear as well as a thumbnail picture of the advertiser's website so a member can also click to see the advertiser's website. A “Search” option so only specific upcoming events come up; i.e. biking, bowling, etc. in the default or other area selected. When clicking an event a map and directions to the event will come up. The events calendar will automatically drop the current day and its events at midnight of that day so the calendar's first page is always the current day. There will be an archive feature in the calendar so a website member can review prior events by week, month, activity type, club and advertiser specific searches. Clubs that have joined/linked to the website will have a user name and password so they can post their upcoming events in this area. Advertisers sponsoring events, i.e. happy hours, restaurant special, merchant discounts, will also have their own user name and password so they can post offerings. There will be a fee charged advertisers, not clubs, to post in this area so some automatic tracking method needs to be incorporated.

“Message Board” will be for members (individuals only) that join the website to post messages about events they plan to attend, comments, etc. Messages will have a “Subject Line”. There also will be a “Location/Current location” and radius box so members can post messages specific to their local area, or a different location they may be traveling to for inquires for information (restaurant suggestions, theatre, special city events, etc.) from residents of those cities. All message postings will appear and there will be a “Search” box where members can enter a specific activity category and/or location to screen messages based on the “Subject Line” and/or “Location/Current location” so if a member is seeking a tennis partner, golf partner, etc. . . . , they can type that key word and only messages relating to that type activity in that location will come up. Members may post private messages so they can ask individual members if they would like to get together for socializing, etc. (getting together for drinks, movies, golf outing, etc.).

“Join Now” will bring up the individual's Join Now template and will have a box to check at the bottom that will require the joining new member to print a membership card which will have a unique membership number, which can be cross indexed with the new member's e-mail address.

“Contact Us” will bring up a template for sending an e-mail message to us. The website will need e-mail capability and we will need to have a generic e-mail address, i.e. administrator socialclubhub.com. This section should have a “Suggestion Box” where members can post suggestions to us for website and service improvements, as well as notify us about their positive or negative experience attending club events and activities. Example:
We want to hear from you.
Questions about our website:
administrator@socialclubhub.com
Suggestions: suggestions@.socialclubhub.com
Advertise with us: advertise@socialclubhub.com
Add a club: listmyclub@socialclubhub.com

“Login” will bring up a box that members and clubs will use to access/login in to our website. Individuals will enter their username and password, clubs and advertisers will have a user name and password. After logging in there needs to be a box for the individual member to “Change My Profile” and “Print My Membership Card” (in case they lost their original one). In one embodiment, a club will be able to “Log In”, and another embodiment another club will only have access to the website through the “Events” tab option, “Join Now” tab option and “Contact Us” tab option. Clubs and advertisers will be able to “Log In” so they can access “Events” and “Deals & Discounts” for posting, as well a “Contact Us”.

“Deals & Discounts” will have a drop down list of advertisers that can be organized alphabetically, geographically (city, state or current location) and by product/service type by using a “search selection menu”. Upon opening “Deals & Discounts” it will default to a radius of 20 miles around our website member's current location and a radius box to select a wider radius. The radius box will show that the default radius is 20 miles. All advertisers that are regional and national will also appear. There will also be a city/state/current location box where the member can change the location in the case when they are going to be traveling to another area and want to see the events in that local area. When clicking a specific advertiser, posted special offers to “Hub” members will appear with a link to the advertiser's website along with a map and directions to the advertiser's designated place of business. There should be tracking software to monitor click thru's to advertisers for sales commission revenue. Advertisers will be able to access this function with their user name and password, and there will be a fee for posting by them. Certain type advertisers (restaurants, bars, art galleries, etc.) may want post the same event/discount on both the “Events” page and the “Deals & Discounts” page, so both these pages should have an option box to check whether they want to post on both pages or select only one of these pages. (Other type advertisers may not want to be on the “Events” page, i.e. florists, hotels, clothing and equipment merchants, etc.). The software should be able to track when a club posts an event on the “Events” calendar, and send an e-mail message to nearby advertisers inquiring whether they would like to offer a special or discount that coordinates with the timing of the club event.

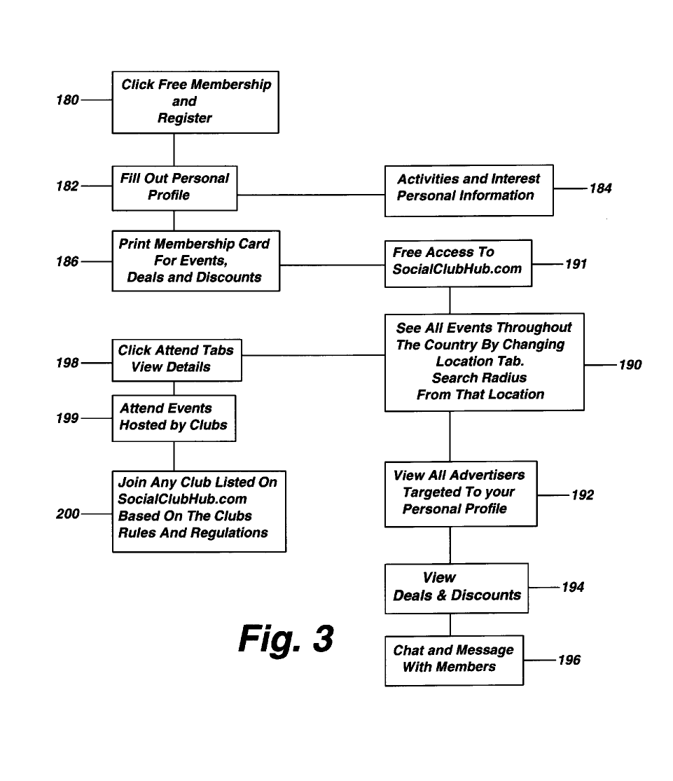

FIG. 3 is a flow diagram depicting an example of a member registration. On the website a potential member can click on a free membership invite 180 and fill out their personal profile 182. Activities and interests are queried 184 as part of the personal information gathering. The personal information is use to help identify club interests. Upon entering of information, a membership card is provided 186 providing access to events, various deals and discounts 186. Access 191 is provided to the private section of the website 188 wherein all events can be searched 190 including a search radius to keep the individual in the immediate area. Advertisers targeted to the personal profile can be viewed 192. Deals and discounts 194 can be reviewed and access to chat and message boards 196 with other members is provided. The membership allows the individual to click on the attend tabs 198 to view the various event details providing access to the events hosted by clubs 194. The member can then joint other clubs 200 listed through the program.

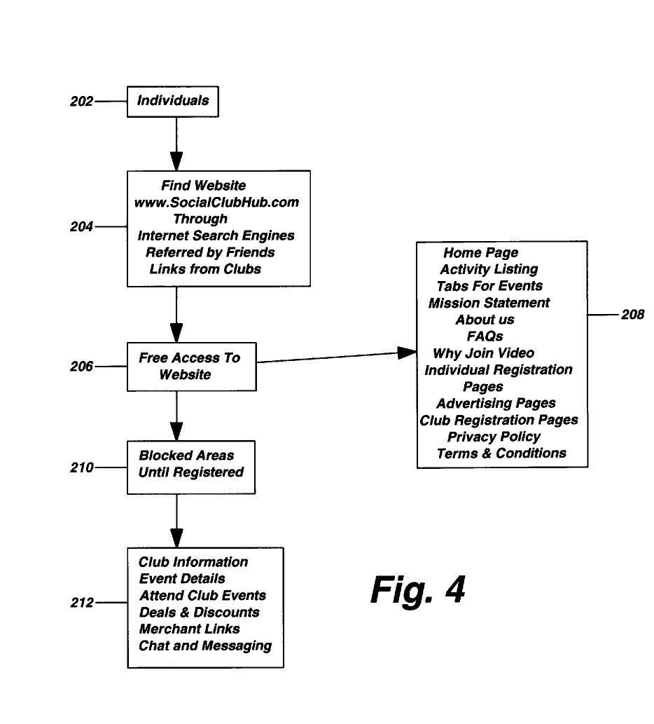

FIG. 4 is a flow diagram depicting individuals not registered 202 wherein the base website 204 is located by use of conventional search engines. The individual is allowed free access 206 to the website wherein mainstream items 208 can be viewed, namely: home page, activity listing, tabs for events, mission statement, about us, FAQs, why join video, individual registration, pages, advertising pages, club registration pages, privacy policy, and terms and conditions. Items blocked 210 until registered include club information, event details, attend club events, deals & discounts, merchant links, chat and messaging.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of displaying club events through a social network environment comprising:
storing calendar based social club events from two or more social clubs on an internet accessible database;
organizing said database of calendar based social club events by interest topic;
displaying each interest topic on an internet accessible computer; and
providing a link between each said interest topic and the social club that is sponsoring said interest topic;
wherein a social club member may view any participating social club displayed event by interest topic for promoting the social club activities of multiple clubs.

2. The method of displaying club events through a social network environment according to claim 1 including the step of generating location information of an event for display with each said interest topic.

3. The method of displaying club events through a social network environment according to claim 2 wherein said location information is associated with the event link such that only events within a set radius will appear.

4. The method of displaying club events through a social network environment according to claim 1 including the step of organizing at least one link to a social club within a set radius of mileage.

5. The method of displaying club events through a social network environment according to claim 1 including the step of organizing said database by individual interests.

6. The method of displaying club events through a social network environment according to claim 1 including the step of organizing said database by social interaction club membership interests.

7. The method of displaying club events through a social network environment according to claim 1 including the step of generating advertising items related to at least on interest topic.

8. The method of displaying club events through a social network environment according to claim 1 including the step of displaying advertisements directed to social club membership interests.

9. The method of displaying club events through a social network environment according to claim 8 including the step of providing a link associated with at least one of said displayed advertisements to the website of the advertiser.

10. The method of displaying club events through a social network environment according to claim 1 wherein said interest topics is selected from the group of arts & crafts, bike/cycling, boating, book, bowling, business group, civic group, computer, cooking, dancing, dining, fishing, game, gardening, golf, hoppy motorcycle, music pet, photography, professional sports, running, scuba diving, snow ski/snowboarding, social group, tennis, travel, volunteer, wine tasting and search groups.

11. The method of displaying club events through a social network environment according to claim 1 including an advertiser merchandise discount display having a link to the advertiser.

12. The method of organizing and displaying independent social club events according to claim 11 wherein only advertisers in a set radius will appear.

13. The method of displaying club events through a social network environment according to claim 11 wherein advertiser information is organized alphabetically.

14. The method of displaying club events through a social network environment according to claim 11 wherein advertiser information is organized geographically.

15. The method of displaying club events through a social network environment according to claim 11 wherein advertiser information is organized by product/service type.

16. The method of displaying club events through a social network environment according to claim 1 further including a message board for posting information from a first social club for receipt and response by a second social club.

17. The method of displaying club events through a social network environment according to claim 1 further including a chat room for at least one individual of a first social club to communicate such that at least one individual of a second social club receives and can respond to such communication.

18. The method of displaying club events through a social network environment according to claim 1 wherein said database stores club member individualized data including hobbies and personal interests.

19. The method of displaying club events through a social network environment according to claim 1 including a link to allow a member of a first social club to become a member of another social club.

20. The method of displaying club events through a social network environment according to claim 1 including click thru's and advertisement views wherein an advertiser pays a pay-per-click or pay-per-view fee each time a person clicks on.

21. The method of displaying club events through a social network environment according to claim 1 including the step of obtaining and confirming attendance to a social event.
